(19) United States
(12) Patent Application Publication
(10) Pub. No.: US 2026/0099907 A1
(43) Pub. Date: Apr. 9, 2026

(54) PROJECTION IMAGE ADJUSTMENT METHOD AND PROJECTOR DEVICE THEREOF

(71) Applicant: BENQ CORPORATION, Taipei City (TW)

(72) Inventor: Chih-Pen Huang, Taipei City (TW)

(73) Assignee: BENQ CORPORATION, Taipei City (TW)

(21) Appl. No.: 19/173,825

(22) Filed: Apr. 9, 2025

(30) Foreign Application Priority Data
Oct. 4, 2024 (TW) 113137772

(51) Int. Cl. G06T 5/80; G03B 21/14; G06T 7/13; G06T 7/90

(52) U.S. Cl. CPC G06T 5/80; G03B 21/142; G06T 7/13; G06T 7/90; G06T 2207/10024

(57) ABSTRACT

A projection image adjustment method is applied to a projector device electrically connected with an external computer apparatus. The projection image adjustment method includes a projection lens of the projector device projecting a projection image which is transmitted from an image output source of the external computer apparatus towards a projection screen, an image detector of the projector device acquiring a detection image relevant to the projection image, an operation processor of the projector device analyzing the detection image to find borders and a border ratio of the projection screen, and transforming the border ratio into a control command for transmitting towards the external computer apparatus, so that the external computer apparatus adjusts an output image ratio of the image output source in accordance with the border ratio.

### BACKGROUND OF THE INVENTION

### 1. Field of the Invention

The present invention relates to a projection image adjustment method and a related projector device, and more particularly, to a projection image adjustment method and a related projector device capable of providing the highly realistic image.

### 2. Description of the Prior Art

With the advanced technology, the golf simulation equipment is widely used in various places because the golf simulation equipment can be installed indoors. The projector of the golf simulation equipment receives the projection image from the external computer, and adjusts the scale of the projection image in accordance with the projection screen, thereby reducing image distortion and achieving an auto-framing function and an auto-focusing function. The golf simulation equipment uses the projector to project the projection image onto the projection screen, but the projection screen may have various sizes; the conventional golf simulation equipment executes the image processing program to change the aspect ratio of the projection image, for making the projection image correctly fit the size of the projection screen, but the original aspect ratio of the projection image may be distorted. Therefore, the image processing program of the conventional golf simulation equipment only adjusts the aspect ratio of the image content provided by the projector, and cannot adjust the original image content provided by the external computer. The conventional golf simulation equipment executes the image processing program to change the projection image transmitted from the projector, which makes it difficult to provide the highly realistic projection effect.

### SUMMARY OF THE INVENTION

The present invention provides a projection image adjustment method and a related projector device capable of providing the highly realistic image for solving above drawbacks.

According to the claimed invention, a projection image adjustment method is applied to a projector device electrically connected with an external computer apparatus. The projection image adjustment method includes a projection lens of the projector device projecting a projection image which is transmitted from an image output source of the external computer apparatus onto a projection screen, an image detector of the projector device acquiring a detection image relevant to the projection image, an operation processor of the projector device analyzing the detection image to find borders and a border ratio of the projection screen, and the operation processor transforming the border ratio into a control command for transmitting towards the external computer apparatus, so that the external computer apparatus adjusts an output image ratio of the image output source in accordance with the border ratio.

According to the claimed invention, a projector device with a projection image adjustment method is matched with an external computer apparatus having an image output source. The projector device includes a projection lens, an image detector and an operation processor. The projection lens is adapted to project a projection image which is transmitted from the image output source onto a projection screen. The image detector is adapted to acquire a detection image relevant to the projection image. The operation processor is electrically connected with the projection lens and the image detector. The operation processor is adapted to analyze the detection image to find borders and a border ratio of the projection screen, and transform the border ratio into a control command for transmitting towards the external computer apparatus, so that the external computer apparatus adjusts an output image ratio of the image output source in accordance with the border ratio.

The projection image adjustment method and the projector device of the present invention can utilize the image detector to capture the detection image containing the projection screen and the projection image when the projection image is projected onto the projection screen by the projection lens; then, the detection image can be analyzed to find out the borders and the border ratio of the projection screen. If the borders and the border ratio of the projection screen are found, the control command with information such as the border ratio (or the screen ratio) can be transmitted to the external computer apparatus, and the external computer apparatus can adjust the output image ratio of the image output source in accordance with the border ratio (or the screen ratio) inside the control command; therefore, the output image ratio of the image output source can be consistent with the border ratio of the projection screen, and the projector device does not need to over-stretch and adjust the projection image in subsequent applications, and does not cause distortion of the aspect ratio of the projection image, thereby effectively achieving the highly realistic projection effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a projector device according to an embodiment of the present invention.

FIG. 2 is an application diagram of the projector device according to the embodiment of the present invention.

FIG. 3 is a flow chart of the projection image adjustment method according to the embodiment of the present invention.

### DETAILED DESCRIPTION

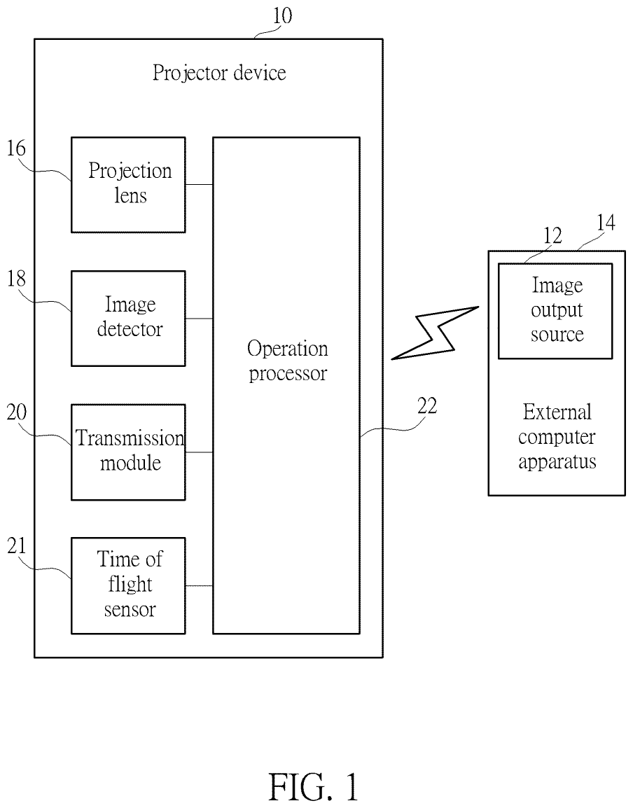

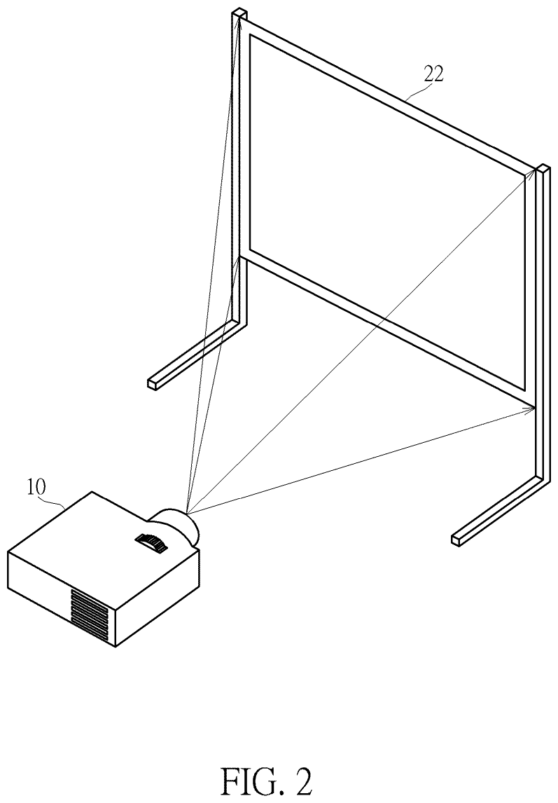

Please refer to FIG. 1 and FIG. 2. FIG. 1 is a functional block diagram of a projector device 10 according to an embodiment of the present invention. FIG. 2 is an application diagram of the projector device 10 according to the embodiment of the present invention. The projector device 10 can be applied to an external computer apparatus 14 having an image output source 12. For example, the projector device 10 can be a golf simulator, the external computer apparatus 14 can be a desktop computer or a notebook computer, and the image output source 12 can optionally be a display card and/or a high-definition multimedia interface of the computer; actual application of the foresaid combination is not limited to the embodiments. The projector device 10 of the present invention can utilize frame matching technology to change an output image ratio of the image output source 12, which means the projector device 10 can change a projection image transmitted from the external computer apparatus 14 to the projector device 10 for avoid the projection image from distortion; the projector device 10 does not stretch the projection image via an image processing program.

The projector device 10 can at least include a projection lens 16, an image detector 18, a transmission module 20, a time of flight (ToF) sensor 21 and an operation processor 22. The projector device 10 can be electrically connected with the external computer apparatus 14 through the transmission module 20 in a wired manner or in a wireless manner, and can receive the projection image provided by the image output source 12. The projection lens 16 can project the projection image onto the projection screen 22. The image detector 18 and the projection lens 16 can be disposed on the same side of the case (which is not shown in the figures) of the projector device 10. The image detector 18 can capture and acquire a detection image relevant to the projection image. The ToF sensor 21 can acquire an angle and a distance of the projector device 10 relative to the projection screen 22. The operation processor 22 can be electrically connected with the projection lens 16, the image detector 18, the transmission module 20 and the ToF sensor 21. The operation processor 22 can execute a projection image adjustment method of the present invention, which can adjust the output image ratio of the projection image provided by the image output source 12 via the external computer apparatus 14.

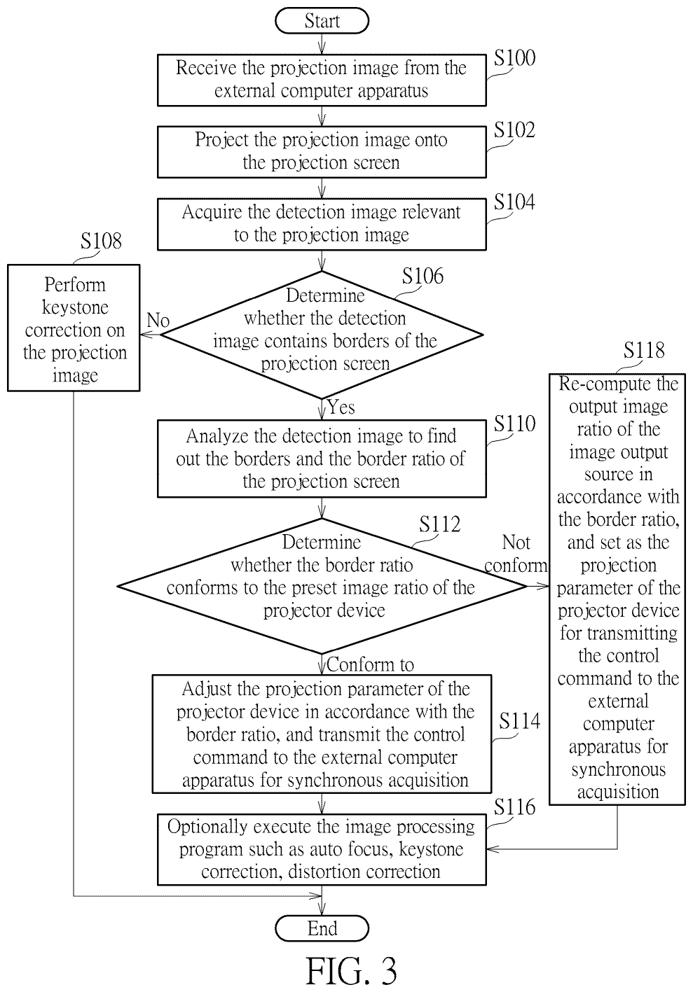

Please refer to FIG. 3. FIG. 3 is a flow chart of the projection image adjustment method according to the embodiment of the present invention. The projection image adjustment method illustrated in FIG. 3 can be suitable for the projector device 10 shown in FIG. 1. For the projection image adjustment method, step S100 and step S102 can be executed that the operation processor 22 can utilize the transmission module 20 to receive the projection image from the image output source 12, and drive the projection lens 16 to project the projection image onto the projection screen 22. In step S102, the projection image adjustment method can preferably adjust the projection image to a maximal zoom ratio and then project the adjusted projection image onto the projection screen 22; a frame aspect ratio of the projection image may usually be one of preset image ratios (such as 1:1, 4:3, 16:9 or 16:10). In addition, the projection image adjustment method can drive the projection lens 16 to project the projection image having a contrasting color with the projection screen 22; for example, the projection image can be a white image, but the actual application is not limited to the foresaid embodiment.

Then, step S104 and step S106 can be executed that the operation processor 22 can drive the image detector 18 to acquire the detection image relevant to the projection image, and analyze and determine whether the detection image contains one or several borders of the projection screen 22. If the detection image does not contain the borders of the projection screen 22, a size of the projection screen 22 can be indicated as being greater than a size of the projection image adjusted to the maximal zoom ratio, and step S108 can be executed to perform keystone correction on the projection image for adjusting the projection image to a rectangular shape. If the detection image contains the borders of the projection screen 22, the size of the projection screen 22 can be indicated as being smaller than the size of the projection image adjusted to the maximal zoom ratio, and step S110 can be executed to analyze the detection image for finding out the borders and a border ratio of the projection screen 22. It should be mentioned that when the image detector 18 acquires the detection image, the projection image adjustment method can optionally analyze the detection image to find out a border color of the projection screen 22, and then determine and adjust the projection image projected in step S102 to have the contrasting color with the border color, which helps step S106 to accurately identify the borders of the projection screen 22.

Step S110 can utilize edge detection technology, image recognition technology, or other possible image analysis technology to find out the borders of the projection screen 22. Generally, the projection screen 22 can be designed as the rectangular shape. When the borders of the projection screen 22 are found, the relative angle and the relative distance of the projection screen 22 acquired by the ToF time of flight sensor 21 can be analyzed to compute lengths of the borders, so as to clearly identify a long border and a short border of the projection screen 22, and an aspect ratio of the long border to the short border can be utilized to compute a border ratio of the projection screen 22. The border ratio can be interpreted as a screen ratio of the projection screen 22.

Then, step S112 can be executed that the operation processor 22 can define the border ratio as the screen ratio of the projection screen 22, and determine whether the screen ratio conforms to the preset image ratio of the projector device 10. The foresaid preset image ratio can be represented as the frame aspect ratio (which is usually 1:1, 4:3, 16:9 or 16:10) of the projection image projected by the projector device 10, and a value of the frame aspect ratio can depend on an actual demand. If the screen ratio of the projection screen 22 can conform to or be close to the preset image ratio of the projector device 10, the size of the projection screen 22 can correspond to built-in data of the projector device 10, and step S114 can be executed to adjust a projection parameter of the projector device 10 in accordance with the screen ratio (for example, step S100 and step S102 are executed to receive and project an initial projection image with the frame aspect ratio of 1:1, and step S110 and step S112 are executed to find out that the screen ratio of the projection screen 22 is 16:9 and then switch the projection parameter to a value of 16:9), and transmit a corresponding control command to the external computer apparatus 14, so that the external computer apparatus 14 can synchronously acquire the latest projection parameter to transmit the corresponding projection image (for example, the adjusted projection image with the frame aspect ratio of 16:9 can be transmitted).

In step S114, the projection parameter of the projector device 10 can be switched to one of the preset image ratios (for example, the foresaid embodiment may switch the projection parameter from the frame aspect ratio of 1:1 to the frame aspect ratio of 16:9); the projection parameter can be interpreted as extended display identification data (EDID), which is used to describe data of the projector device 10, such as the video resolution and audio format. In addition, the external computer apparatus 14 can synchronously acquire the projection parameter (which means the extended display identification data), and can further adjust and transmit the projection image (which means the adjusted projection image with the frame aspect ratio of 16:9) with the corresponding output image ratio in accordance with the projection parameter through the image output source 12. Then, step S116 can be executed that the operation processor 22 execute the image processing program such as auto focus, keystone correction, distortion correction, to ensure that the projection lens 16 can project the clear and correct projection image.

If the screen ratio of the projection screen 22 does not conform to the preset image ratio of the projector device 10, or is significantly different from the preset image ratio, the size of the projection screen 22 cannot correspond to the built-in data of the projector device 10 (for example, the border ratio or the screen ratio of 5:3 found in step S110 is obviously different from the preset image ratio of 1:1, 4:3, 16:9 and 16:10), and step S118 can be executed that the operation processor 22 can re-compute the output image ratio (which means the value of 5:3) of the image output source 12 in accordance with the screen ratio, and set the output image ratio as the projection parameter (which means the value of 5:3) of the projector device 10, and then transmit the corresponding control command to the external computer apparatus 14, so that the external computer apparatus 14 can synchronously acquire the latest projection parameter for transmitting the related projection image (for example, the adjusted projection image with the frame aspect ratio of 5:3 can be transmitted). Final, the projection image adjustment method can execute step S116 to perform fine adjustment by the common image processing program so that the projection lens 16 can project the clear and correct projection image.

In conclusion, the projection image adjustment method and the projector device of the present invention can utilize the image detector to capture the detection image containing the projection screen and the projection image when the projection image is projected onto the projection screen by the projection lens; then, the detection image can be analyzed to find out the borders and the border ratio of the projection screen. If the borders and the border ratio of the projection screen are found, the control command with information such as the border ratio (or the screen ratio) can be transmitted to the external computer apparatus, and the external computer apparatus can adjust the output image ratio of the image output source in accordance with the border ratio (or the screen ratio) inside the control command; therefore, the output image ratio of the image output source can be consistent with the border ratio of the projection screen, and the projector device does not need to over-stretch and adjust the projection image in subsequent applications, and does not cause distortion of the aspect ratio of the projection image, thereby effectively achieving the highly realistic projection effect.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projection image adjustment method applied to a projector device electrically connected with an external computer apparatus, the projection image adjustment method comprising:
a projection lens of the projector device projecting a projection image which is transmitted from an image output source of the external computer apparatus onto a projection screen;
an image detector of the projector device acquiring a detection image relevant to the projection image;
an operation processor of the projector device analyzing the detection image to find borders and a border ratio of the projection screen; and
the operation processor transforming the border ratio into a control command for transmitting towards the external computer apparatus, so that the external computer apparatus adjusts an output image ratio of the image output source in accordance with the border ratio.

2. The projection image adjustment method of claim 1, further comprising:
the operation processor controlling the projection lens to adjust the projection image to a maximal zoom ratio for projecting onto the projection screen.

3. The projection image adjustment method of claim 1, further comprising:
the operation processor analyzing a border color of the projection screen, and driving the projection lens to project the projection image having a contrasting color with the border color.

4. The projection image adjustment method of claim 1, further comprising:
the operation processor performing keystone correction on the projection image when the borders of the projection screen are not found inside the detection image.

5. The projection image adjustment method of claim 1, further comprising:
the operation processor utilizing edge detection technology to determine whether the detection image contains the borders, and computing the border ratio by lengths of the borders.

6. The projection image adjustment method of claim 1, further comprising:
the operation processor acquiring a screen ratio of the projection screen in accordance with the border ratio, and determining whether the screen ratio conforms to a preset image ratio of the projector device.

7. The projection image adjustment method of claim 6, further comprising:
the operation processor adjusting a projection parameter of the projector device in accordance with the screen ratio when the screen ratio conforms to the preset image ratio, and utilizing the control command to allow the external computer apparatus to synchronously acquire the projection parameter.

8. The projection image adjustment method of claim 6, further comprising:
the operation processor re-computing the output image ratio of the image output source in accordance with the screen ratio when the screen ratio does not conform to the preset image ratio.

9. The projection image adjustment method of claim 6, further comprising:
the operation processor setting the screen ratio as a projection parameter of the projector device when the screen ratio does not conform to the preset image ratio, and utilizing the control command to allow the external computer apparatus to synchronously acquire the projection parameter.

10. The projection image adjustment method of claim 1, further comprising:
the operation processor utilizing a time of flight sensor of the projector device to acquire a relative angle and a relative distance of the projection screen.

11. A projector device with a projection image adjustment method and matched with an external
computer apparatus having an image output source, the projector device comprising:
a projection lens adapted to project a projection image which is transmitted from the image output source onto a projection screen;
an image detector adapted to acquire a detection image relevant to the projection image; and
an operation processor electrically connected with the projection lens and the image detector, the operation processor being adapted to analyze the detection image to find borders and a border ratio of the projection screen, and transform the border ratio into a control command for transmitting towards the external computer apparatus, so that the external computer apparatus adjusts an output image ratio of the image output source in accordance with the border ratio.

12. The projector device of claim 11, wherein the operation processor is adapted to further control the projection lens to adjust the projection image to a maximal zoom ratio for projecting onto the projection screen.

13. The projector device of claim 11, wherein the operation processor is adapted to further analyze a border color of the projection screen, and drive the projection lens to project the projection image having a contrasting color with the border color.

14. The projector device of claim 11, wherein the operation processor is adapted to further perform keystone correction on the projection image when the borders of the projection screen are not found inside the detection image.

15. The projector device of claim 11, wherein the operation processor is adapted to further utilize edge detection technology to determine whether the detection image contains the borders, and compute the border ratio by lengths of the borders.

16. The projector device of claim 11, wherein the operation processor is adapted to further acquire a screen ratio of the projection screen in accordance with the border ratio, and determine whether the screen ratio conforms to a preset image ratio of the projector device.

17. The projector device of claim 16, wherein the operation processor is adapted to further adjust a projection parameter of the projector device in accordance with the screen ratio when the screen ratio conforms to the preset image ratio, and utilize the control command to allow the external computer apparatus to synchronously acquire the projection parameter.

18. The projector device of claim 16, wherein the operation processor is adapted to further compute the output image ratio of the image output source in accordance with the screen ratio when the screen ratio does not conform to the preset image ratio.

19. The projector device of claim 16, wherein the operation processor is adapted to further set the screen ratio as a projection parameter of the projector device when the screen ratio does not conform to the preset image ratio, and utilize the control command to allow the external computer apparatus to synchronously acquire the projection parameter.

20. The projector device of claim 11, wherein the operation processor is adapted to further utilize a time of flight sensor of the projector device to acquire a relative angle and a relative distance of the projection screen.
